(19) United States
(12) Patent Application Publication
(10) Pub. No.: US 2010/0084426 A1
(43) Pub. Date: Apr. 8, 2010

(54) Portable self-serve beer vending station

(76) Inventors: Jeffrey M. Devers, Santa Barbara, CA (US); Jeffrey H. Devers, Clinton Township, MI (US)

Correspondence Address: LITMAN LAW OFFICES, LTD., POST OFFICE BOX 41200, SOUTH STATION, ARLINGTON, VA, 22204, US

(21) Appl. No.: 12/588,211

(22) Filed: Oct. 7, 2009

Related U.S. Application Data
(60) Provisional application No. 61/136,852, filed on Oct. 8, 2008.

(51) Int. Cl. B67D 7/10; B60P 3/22; B67D 7/06

(52) U.S. Cl. 222/2; 222/608; 222/144.5

(57) ABSTRACT

The portable self-serve beer vending station has a hollow base in which at least two beer kegs are stored. A shelf of the unit is disposed above the base, two or more beer taps being disposed above the shelf to service each keg. A manifold tube extends from the kegs to the beer taps. Money machines, one on each side of the station, accept cash, credit, or debit. The money machine control wires are connected to control valves connected between the manifold outlets and the taps. Each money machine provides a touch screen selection menu or pushbuttons from which patrons can select either a pitcher or mug of beer at a set price. The station may be cylindrical, hexagonal, rectangular, semicircular, or the like. A surround shelf is provided for filling pitchers or mugs. An upper shelf is provided for holding fresh pitchers or mugs.

### CROSS-REFERENCE TO RELATED APPLICATION

This application claims the benefit of U.S. Provisional Patent Application Ser. No. 61/136,852, filed Oct. 8, 2008.

### BACKGROUND OF THE INVENTION

1. Field of the Invention

The present invention relates to apparatus and methods for selling alcoholic beverages, and particularly to a portable self-serve beer vending station that automatically dispenses beer upon payment therefore.

2. Description of the Related Art

Parties, often known as keggers, in which multiple kegs of beer are placed at the party location for consumption by the party goers have become very popular among university students and the like. Often the sponsoring entity may be a fraternity, sorority or the like. These organizations generally have limited budgets, and after purchase of the multiple kegs, may not have the necessary funds to pay a bartender. People like beer. People like to have their beer when and wherever they want it. However, it is imperative that People must pay for their beer. It would be advantageous to have a bartender-less beer keg dispensing unit that could easily be dispatched to the party location.

Thus, a portable self-serve beer vending station solving the aforementioned problems is desired.

### SUMMARY OF THE INVENTION

The portable self-serve beer vending station is a portable, metered, freestanding, self-serve beer station that has a hollow base in which at least two beer kegs are stored. A shelf of the unit is disposed above the base, two or more beer taps being disposed above the shelf to service each keg. A manifold tube extends from the kegs to the beer taps. Money machines, one on each side of the station, accept cash, credit, or debit. The money machine control wires are connected to control valves connected between the manifold outlets and the taps. Each money machine provides a touch screen selection menu or pushbuttons from which patrons can select either a pitcher or mug of beer at a set price. The station may be cylindrical, hexagonal, rectangular, semi-circular, or the like, so that it can be pushed against a wall.

A surround shelf is provided for filling pitchers or mugs. An upper shelf is provided for holding fresh pitchers or mugs.

Different models are used for indoor and outdoor functions, such as picnics and barbeques. The stations can also be rented and delivered directly to the user.

These and other features of the present invention will become readily apparent upon further review of the following specification and drawings.

### BRIEF DESCRIPTION OF THE DRAWINGS

FIG. 1 is an environmental, perspective view of a portable self-serve beer vending station according to the present invention.

FIG. 2 is a block diagram of the portable self-serve beer vending station according to the present invention.

FIG. 3 is a front view of a currency box of the portable self-serve beer vending station according to the present invention.

Similar reference characters denote corresponding features consistently throughout the attached drawings.

### DETAILED DESCRIPTION OF THE PREFERRED EMBODIMENT

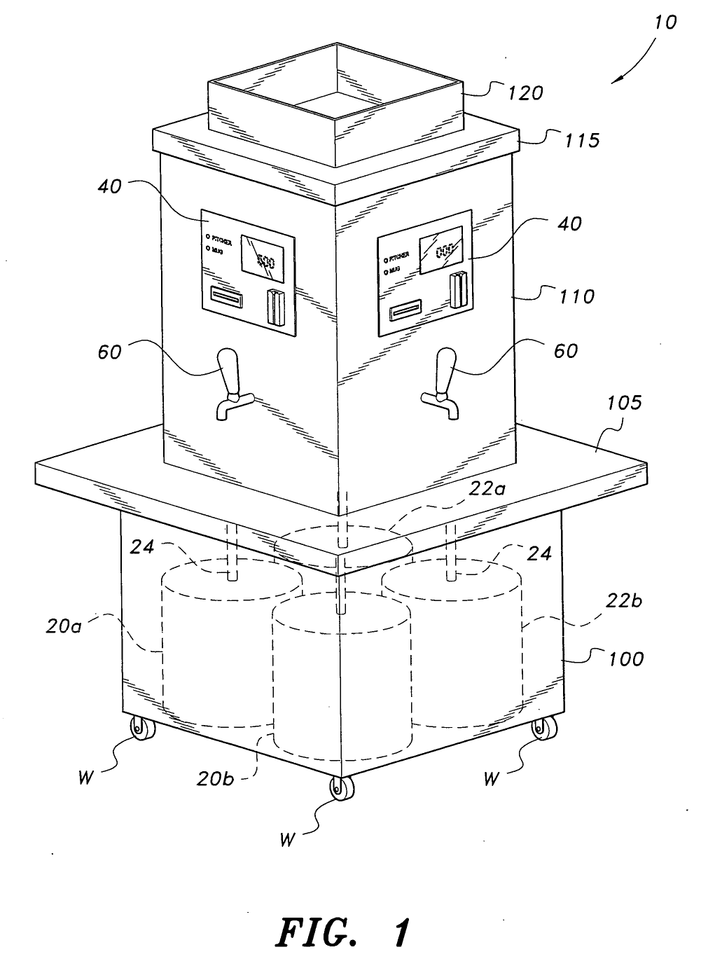

Referring now to FIGS. 1-3, the portable self-serve beer vending station includes a vending dispenser 10 that preferably has a plurality of taps 60. The beer vending unit 10 has a hollow base 100 in which a beer keg, and preferably at least two beer kegs, is stored. Wheels W are attached to the bottom of base 100 to facilitate ease of portability of the unit 10. A lower shelf 105 extends outward from an upper portion of base 100, at least one beer tap 60 being disposed on a tower portion 110 above the first shelf 105 to service each keg stored within base 100. The lower shelf 105 is provided for filling pitchers or mugs. An upper shelf 115 extends from an upper portion of tower 110 and is provided for holding fresh pitchers or mugs. A plurality of vertical walls 120 extend from upper shelf 115. The vertical walls can accept company logos, advertising, or the like, for prominent display on the unit 10. The station may be cylindrical, hexagonal, rectangular, semicircular, or the like, so that it can be pushed against a wall.

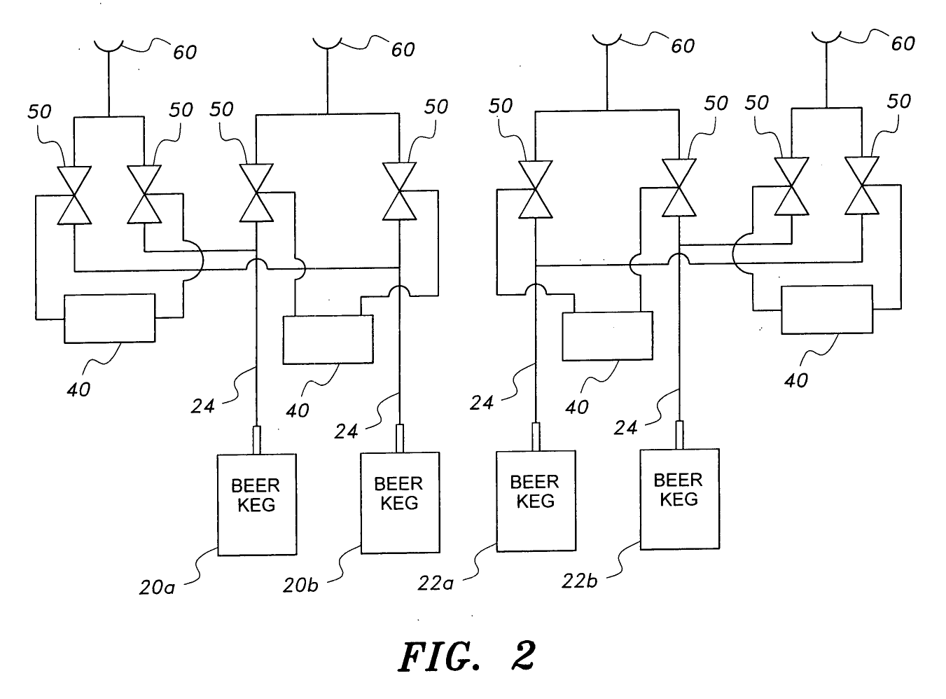

As shown in FIG. 2, the flow of beer through the taps 60 is controlled by means of a plurality of control valves 50, each of which is electrically connected to a control output of an electronic money machine 40.

The control valves 50 interconnect the taps 60 and a plurality of manifold supply lines 24, which are, in turn, connected to kegs of beer 20a, 20b, 22a, and 22b, the beer kegs being stored within the hollow base 100 of the vending unit 10.

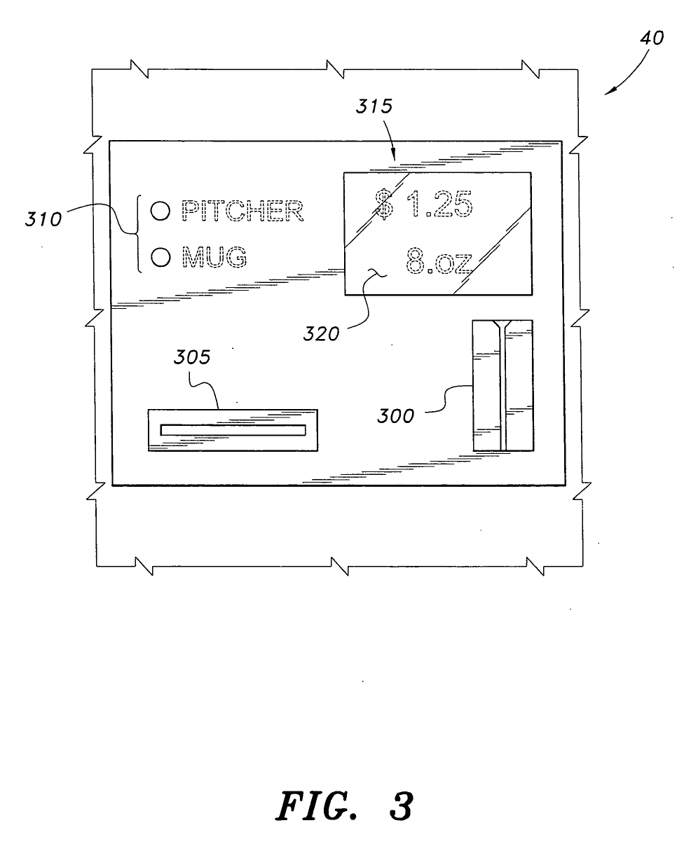

As most clearly shown in FIG. 3, the money machine 40 has pitcher/mug selection buttons 310. A digital display 315 can display any menus required for beer selection. Additionally, numeric displays 320 show the amount of money required for purchase as well as the amount (quantity) of beer being dispensed with the user's purchase. A coin and bill slot 305 is provided as well as a credit card/debit card slot 300.

Thus, when a patron deposits money in the money machine 40 and selects a beer type and amount from options provided by the money machine, the money machine 40 sends a signal to the appropriate control valve 50 for an appropriate duration to cause the beer to flow through the supply line 24 to the tap 60 thereby dispensing to the patron the selected quantity of the selected beer from one of kegs 20a, 20b, 22a, 22b.

It is to be understood that the present invention is not limited to the embodiment described above, but encompasses any and all embodiments within the scope of the following claims.

We claim:

1. A portable self-serve beer vending station, comprising:
a hollow base adapted for receiving a plurality of beer kegs within;
a lower shelf extending outward from the base, the lower shelf being adapted for supporting containers for receiving beer;
a tower extending upward from the lower shelf;
a plurality of beer taps disposed on the tower;
at least one manifold tube attachable to the beer kegs;
at least one control valve interconnecting an outlet of the at least one manifold tube to at least one of the beer taps; and
a money machine disposed on the tower, the money machine accepting money and beer selection from a customer, the money machine sending a control signal to open the at least one control valve.

2. The portable self-serve beer vending station according to claim 1, further comprising a plurality of wheels attached to the bottom of the base, thereby facilitating ease of portability of the vending station.

3. The portable self-serve beer vending station according to claim 1, wherein the tower has four vertically extending planar surfaces, each of said surfaces having one of said beer taps and one of said money machine.

4. The portable self-serve beer vending station according to claim 1, wherein said at least one control valve comprises two control valves, each of the control valves having one of the beer taps operably connected thereto in order to enable a user to selectively receive one of two types of beer from the tap being operated by the user.

5. The portable self-serve beer vending station according to claim 1, wherein the base is dimensioned and configured for receiving four beer kegs therein.

6. The portable self-serve beer vending station according to claim 1, wherein the money machine has pitcher/mug selection buttons and a digital display presenting menus required for beer selection.

7. The portable self-serve beer vending station according to claim 6, wherein the display includes a numeric presentation showing the amount of money required for purchase as well as the amount (quantity) of beer being dispensed with the user's purchase.

8. The portable self-serve beer vending station according to claim 1, wherein the money machine includes a coin and bill as well as a credit card/debit card slot.

9. The portable self-serve beer vending station according to claim 1, further comprising:
an upper shelf extending from an upper portion of the tower, said upper shelf providing a surface for fresh pitchers or mugs; and
a plurality of vertical walls extending from said upper shelf, said vertical walls accepting indicia for prominent display on the vending station.

10. The portable self-serve beer vending station according to claim 1, wherein the station is dimensioned and configured for being pushed against a wall.
